(19) United States
(12) Patent Application Publication
(10) Pub. No.: US 2008/0295779 A1
(43) Pub. Date: Dec. 4, 2008

(54) Cage cleaning device

(76) Inventor: Debra A. Dehoff, York, PA (US)

Correspondence Address: JAMES RAY & ASSOCIATES, 2640 PITCAIRN ROAD, MONROEVILLE, PA, 15146, US

(21) Appl. No.: 12/154,084

(22) Filed: May 20, 2008

Related U.S. Application Data
(60) Provisional application No. 60/940,707, filed on May 30, 2007.

(51) Int. Cl. A01K 1/01; A46B 5/00; A46B 9/00; A47L 13/02

(52) U.S. Cl. 119/479; 15/144.4; 15/171; 15/236.01

(57) ABSTRACT

A cage cleaning device is provided. Such cage cleaning device includes an elongated rod member manufactured from a first predetermined material and having a first predetermined size, a first predetermined shape and a first predetermined length. A cleaning member including at least one of at least one scraping member for cleaning a bottom portion of a pet cage, at least one pointed member for cleaning corners of a pet cage, at least one notched member for cleaning in between bars of a pet cage, at least one cut out portion for cleaning bars of a pet cage, and a combination thereof is operably connected to such elongated rod member at a first predetermined end thereof. The cleaning member is manufactured from a second predetermined material and has a second predetermined size and a second predetermined shape.

### CROSS REFERENCE TO RELATED APPLICATION

This patent application is related to and claims priority from U.S. Provisional Patent Application Ser. No. 60/940,707 filed May 30, 2007.

### FIELD OF THE INVENTION

The present invention relates, in general, to cleaning devices and, more particularly, this invention relates to pet cage cleaning devices.

### BACKGROUND OF THE INVENTION

Prior to the conception and development of the present invention, pet cages, as are generally well known in the prior art, have been used to house and transport pets. Such cages are often difficult to clean, especially bird cages. Birds move around their cages and often defecate on the cage bars and in the corners of their cages. Bird droppings quickly dry and harden making them very difficult to remove especially in the corners of the cage, in the areas where the walls and bottom of the cage meet, and on and in between the cage bars. Cleaning the cage can be time consuming and unpleasant for both the pet and the cleaning person. Therefore there exists a need for a cage cleaning device which can be used to clean difficult to reach areas of cages including corners and in between cage bars.

Specifically of interest to the present invention is the following: Thompson, et al, U.S. Pat. No. 4,256,510, discloses a drum-type rotary scraper, for use in a corner, scraping a surface by the snapping reformation of elastically restrained portions of flexible fingers deformed from their normal circular path by the constraint of the planes forming the corner.

### SUMMARY OF THE INVENTION

The present invention provides a cage cleaning device. Such cage cleaning device includes an elongated rod member manufactured from a first predetermined material and having a first predetermined size, a first predetermined shape and a first predetermined length. A cleaning member includes at least one of at least one scraping member for cleaning a bottom portion of a pet cage, at least one pointed member for cleaning corners, at least one notched member for cleaning in between bars of a pet cage, at least one cut out portion for cleaning bars of a pet cage, and a combination thereof. Such cleaning member is operably connected to such elongated rod member at a first predetermined end thereof. Such cleaning member is manufactured from a second predetermined material and has a second predetermined size and a second predetermined shape.

According to another embodiment, a cage cleaning device is provided which includes an elongated rod member manufactured from a first predetermined material and having a first predetermined size, a first predetermined shape and a first predetermined length. A first cleaning member, including at least one of at least one scraping member for cleaning a bottom portion of a pet cage, at least one pointed member for cleaning corners, at least one notched member for cleaning in between bars of a pet cage, at least one cut out portion for cleaning bars of a pet cage, and a combination thereof, is operably connected to such elongated rod member at a first predetermined end thereof. Such first cleaning member is manufactured from a second predetermined material and has a second predetermined size and a second predetermined shape. A second cleaning member is operably and releasably connected to such elongated rod member at a predetermined location thereon. A securing means is operably connected to such second cleaning member at a predetermined location thereon for releasably securing such second cleaning member to such elongated rod member.

### OBJECTS OF THE INVENTION

It is, therefore, one of the primary objects of the present invention to provide a cage cleaning device that can be used to scrape dried pet droppings from the surfaces of a pet cage of any size.

Another object of the present invention is to provide a cage cleaning tool which has a cleaning member having multiple notches for cleaning in between and around the bars of a pet cage.

Still another object of the present invention is to provide a cage cleaning device which includes a removable brush member for cleaning various parts of such cage.

Yet another object of the present invention is to provide a cage cleaning device which includes a reusable brush member which can be washed in a dishwasher.

An additional object of the present invention is to provide a cage cleaning device which has an extendable handle.

Still another object of the present invention is to provide a cage cleaning device which includes at least one cleaning member having multiple cleaning surfaces thereon.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention in which includes a cleaning brush.

FIG. 3 is a partial perspective view of the invention according to one embodiment of the invention in which the brush has been detached from the cage cleaning device.

FIG. 4 is a partial perspective view of the invention according to one embodiment of the invention in which a cleaning member is disposed at each end of the handle member.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

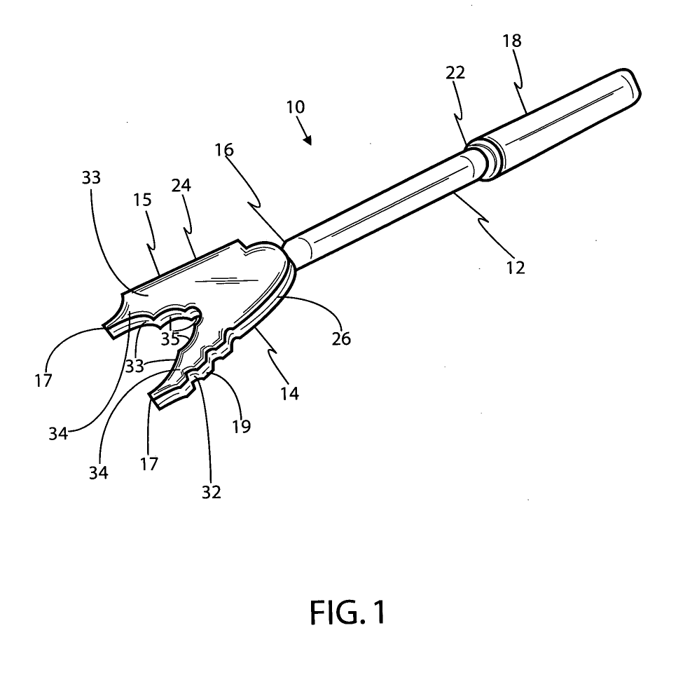

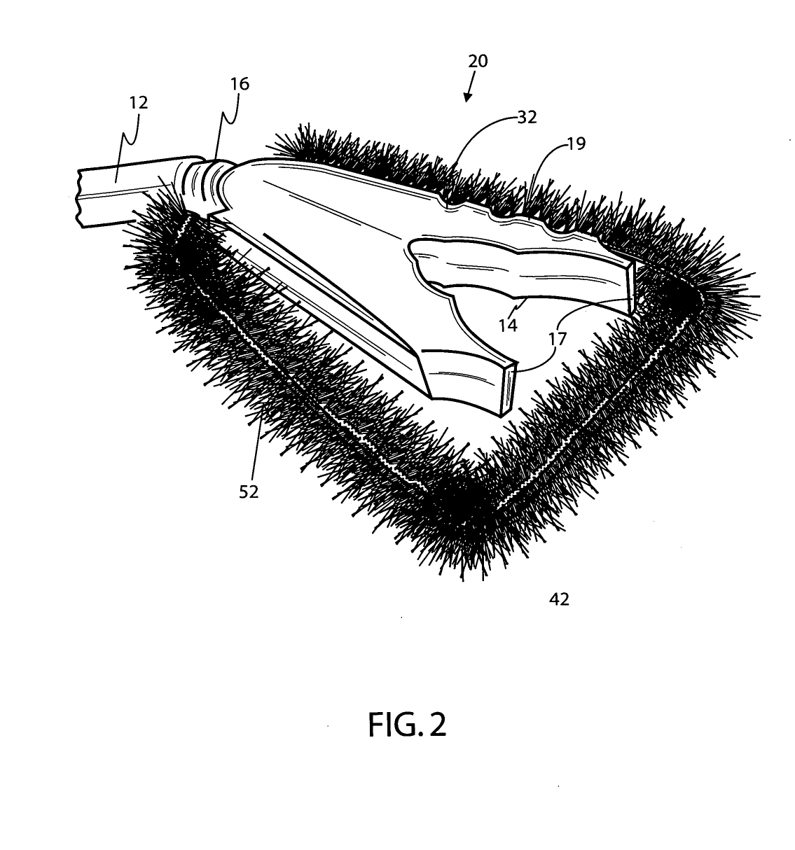

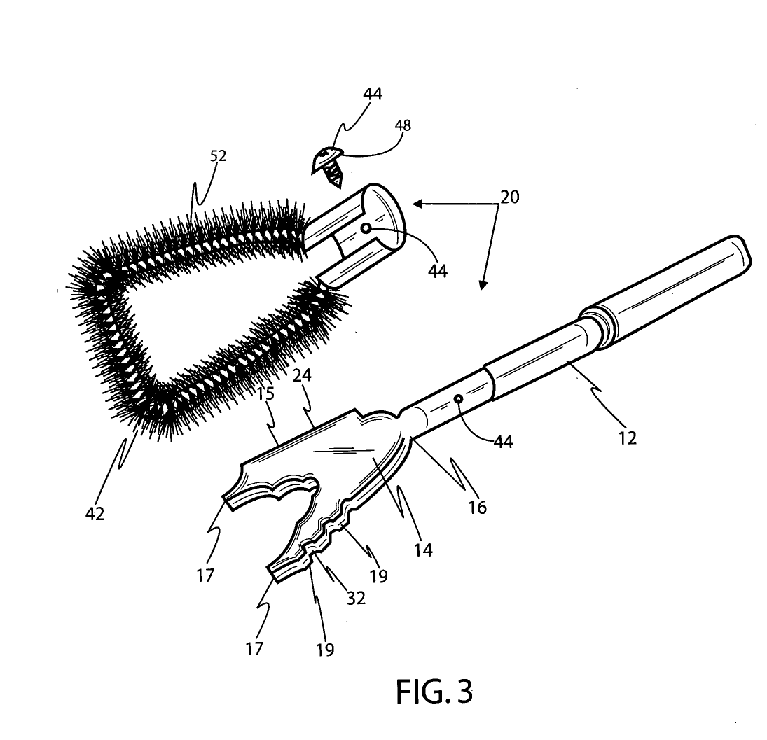

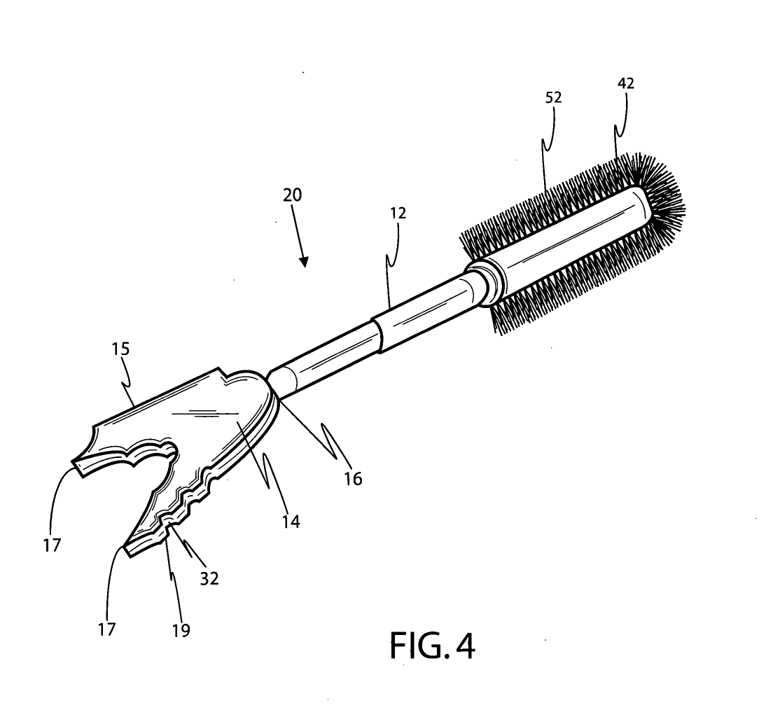

Reference is now made, more particularly, to FIGS. 1-4.

A cage cleaning device, generally designated 10 is provided. Such cage cleaning device 10 includes an elongated rod member 12 manufactured from a first predetermined material and having a first predetermined size and a first predetermined shape and a first predetermined length.

It is presently preferred that such first predetermined material is at least one of metal and plastic. It is presently most preferred that such first predetermined material is metal. It is presently preferred that such metal is stainless steel.

A cleaning member 14, including at least one of at least one scraping member 15 for cleaning a bottom of a pet cage, at least one pointed member 17 for cleaning corners of a pet cage, at least one notched member 19 for cleaning in between bars of a pet cage, at least one cut out portion 32 for cleaning in between bars of a pet cage, and a combination thereof, is operably connected to the elongated rod member 12 at a first predetermined end 16 thereof.

The cleaning member 12 is manufactured from a second predetermined material and has a second predetermined size and a second predetermined shape. It is presently preferred that such second predetermined material is at least one of metal and plastic. It is presently most preferred that such second predetermined material is metal. It is presently preferred that such metal is stainless steel.

It is presently preferred that such elongated rod member 12 is telescoping. It is presently preferred that such elongated rod member can be extended to a length of between about 14.00 inches and 22.00 inches. It is further presently preferred that such elongated rod member 12 is substantially cylindrical.

It is presently preferred that such cage cleaning device 10 includes a handle member 18 manufactured from a third predetermined material and having a third predetermined size and a third predetermined shape, such handle member 18 being operably connected to such elongated rod member 14 at a second predetermined end 22 thereof. It is presently preferred that such handle member is rubber. It is presently preferred that such handle member is between about 6.0 inches and 10.0 inches long.

It is presently preferred that such cleaning member 14 is attached to the elongated rod member 12 at a predetermined angle.

It is presently preferred that such predetermined angle is about a 45 degree angle.

It is presently preferred that such cleaning member 14 includes at least one beveled edge 24.

It is presently preferred that at least one predetermined side 26 of such cleaning member 14 includes at least one of a plurality of notched members 19, a plurality of cut out portions 32, and a combination thereof. It is presently preferred that each of such notched members 19 are generally about 10 mm wide. It is presently preferred that each of such cut out portions 32 are at least one of about 2 mm wide, about 2 mm deep, and a combination thereof.

It is further presently preferred that at least a second predetermined side 33 of such cleaning member 14 includes a scraping member 15 disposed thereon. It is presently preferred that such scraping member is about 3.0 cm long and about 5.0 mm wide.

It is presently preferred that such cleaning member 14 includes a plurality of cleaning arms 34, each of such cleaning arms 34 including at least one of such at least one scraping member 15, such at least one pointed member 17, such at least one notched member 19, such at least one cut out portion 32, and a combination thereof.

It is presently preferred that respective inside portions 33 of each of such cleaning arms 34 each include rounded cut out portions 35 for cleaning cage bars.

According to another embodiment, a cage cleaning device, generally designated 20, is provided which includes an elongated rod member 12 manufactured from a first predetermined material and having a first predetermined size, a first predetermined shape and a first predetermined length.

A first cleaning member 14, including at least one of at least one scraping member 15 for cleaning a bottom portion of a pet cage, at least one pointed member 17 for cleaning corners, at least one notched member 19 for cleaning in between bars of a pet cage, at least one cut out portion 32 for cleaning bars of a pet cage, and a combination thereof, is operably connected to the elongated rod member 12 at a first predetermined end 16 thereof, the cleaning member 14 is manufactured from a second predetermined material and has a second predetermined size and a second predetermined shape.

A second cleaning member 42 is operably and releasably connected to the elongated rod member 12 at a predetermined location thereon.

A securing means 44 is operably connected to such second cleaning member 42 at a predetermined location thereon for releasably securing such second cleaning member 42 to the elongated rod member 12.

It is presently preferred that such securing means 44 is at least one of a screw type securing means and a clamp type securing means. However, such securing means may be any type of securing means which will facilitate releasably attaching such second cleaning member 42 to the elongated rod member 12.

It is presently most preferred that such securing means 44 is a screw type securing means 48.

It is presently preferred that such second cleaning member 42 is at least one of a brush, a sponge, and a mop type cleaning member. It is presently most preferred that such second cleaning member 42 is a brush 52. It is presently preferred that such brush 52 is dishwasher safe. It is further presently preferred that such brush has bristles made of plastic.

It is presently preferred that such second cleaning member 42 is releasably attachable to such elongated rod member at a predetermined angle. It is presently preferred that such predetermined angle is about a 45 degree angle.

Such second cleaning member 42 may be formed such that when attached to the elongated rod member 12, such second cleaning member 42 extends around the perimeter of such first cleaning member 14. However, the invention is not meant to be limited as such, but the second cleaning member 42 may be attached in any manner and to any location on such cage cleaning device 20 conducive to enabling such user to utilize such cage cleaning device 20.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A cage cleaning device comprising;
a. an elongated rod member manufactured from a first predetermined material and having a first predetermined size and a first predetermined shape and a first predetermined length; and
b. a cleaning member including at least one of at least one scraping member for cleaning a bottom portion of a pet cage, at least one pointed member for cleaning corners of a pet cage, at least one notched member for cleaning in between bars of a pet cage, at least one cut out portion for cleaning bars of a pet cage, and a combination thereof, said cleaning member being operably connected to said elongated rod member at a first predetermined end thereof, said cleaning member being manufactured from a second predetermined material and having a second predetermined size and a second predetermined shape.

2. A cage cleaning device according to claim 1 wherein said elongated rod member is telescoping.

3. A cage cleaning device according to claim 1 wherein said elongated rod member is substantially cylindrical.

4. A cage cleaning device according to claim 1 wherein said cage cleaning device further includes a handle member manufactured from a third predetermined material and having a third predetermined size and a third predetermined shape, said handle member being operably connected to said elongated rod member at a second predetermined end thereof.

5. A cage cleaning device according to claim 1 wherein said cleaning member is attached to said elongated rod member at a predetermined angle.

6. A cage cleaning device according to claim 5 wherein said predetermined angle is about a 45 degree angle.

7. A cage cleaning device according to claim 1 wherein said cleaning member includes at least one beveled edge.

8. A cage cleaning device according to claim 1 wherein at least a first predetermined side of said cleaning member includes at least one of a plurality of notched members, a plurality of cut out portions, and a combination thereof disposed thereon.

9. A cage cleaning device according to claim 8 wherein each of said notched members is generally about 10 mm wide.

10. A cage cleaning device according to claim 8 wherein each of said cut out portions are at least one of about 2 mm wide, about 2 mm deep, and a combination thereof.

11. A cage cleaning device according to claim 8 wherein at least a second predetermined side of said cleaning member includes a scraping member disposed at a predetermined location thereon.

12. A cage cleaning device according to claim 1 wherein said cleaning member includes a plurality of cleaning arms, each of said cleaning arms including at least one of said at least one scraping member, said at least one pointed member, said at least one notched member, said at least one cut out portion, and a combination thereof.

13. A cage cleaning device comprising:
a. an elongated rod member manufactured from a first predetermined material and having a first predetermined size and a first predetermined shape and a first predetermined length; and
b. a first cleaning member including at least one of at least one scraping member for cleaning a bottom portion of a pet cage, at least one pointed member for cleaning corners, at least one notched member for cleaning in between bars of a pet cage, at least one cut out portion for cleaning bars of a pet cage, and a combination thereof, said first cleaning member being operably connected to said elongated rod member at a first predetermined end thereof, said first cleaning member being manufactured from a second predetermined material and having a second predetermined size and a second predetermined shape; and
c. a second cleaning member operably and releasably connected to said elongated rod member at a predetermined location thereon; and
d. a securing means operably connected to said second cleaning member at a predetermined location thereon for releasably securing said second cleaning member to said elongated rod member.

14. A cage cleaning device according to claim 13 wherein said securing means is at least one of a screw type securing means and a clamp type securing means.

15. A cage cleaning device according to claim 14 wherein said securing means is a screw type securing means.

16. A cage cleaning device according to claim 13 wherein said second cleaning member is at least one of a brush, a sponge, and a mop type cleaning member.

17. A cage cleaning device according to claim 16 wherein said second cleaning member is a brush.

18. A cage cleaning device according to claim 17 wherein said brush is dishwasher safe.

19. A cage cleaning device according to claim 13 wherein said second cleaning member is releasably attachable to said handle member at a predetermined angle.

20. A cage cleaning device according to claim 19 wherein said predetermined angle is about a 45 degree angle.
